(19) United States
(12) Patent Application Publication
(10) Pub. No.: US 2021/0237393 A1
(43) Pub. Date: Aug. 5, 2021

(54) SLIP RESISTANT EXERCISE MAT

(71) Applicant: Ming Yu Hsieh, Taichung City (TW)

(72) Inventor: Ming Yu Hsieh, Taichung City (TW)

(73) Assignee: WHEELSTONE ENTERPRISE CO., LTD., Taichung City (TW)

(21) Appl. No.: 16/781,111

(22) Filed: Feb. 4, 2020

(51) Int. Cl. B32B 3/26; B32B 3/30; A47G 27/02

(52) U.S. Cl. CPC B32B 3/266; B32B 3/30; B32B 2471/04; B32B 2307/744; A47G 27/0212

(57) ABSTRACT

An exercise mat includes a fabric layer including holes and having a joining surface on a first surface and a sweat absorbing surface on a second surface; and an elastic slip resistant layer having a slip resistant surface on a first surface and a joining surface on a second surface. The joining surface of the elastic slip resistant layer includes slip resistant protuberances each disposed in the hole.

### BACKGROUND OF THE INVENTION

### 1. Field of the Invention

The invention relates to exercise mats and more particularly to an exercise mat having a fabric layer and an elastic slip resistant layer secured together by sulfurizing, melting or gluing with portions of a joining surface of the elastic slip resistant layer moved to abutting positions of a plurality of holes of the fabric layer so as to bring about a stronger fastening effect to the joining surfaces of both the fabric layer and the elastic slip resistant layer, thereby rendering the exercise mat to be slip resistant.

### 2. Description of Related Art

A conventional exercise mat is shown in FIGS. 7 and 8 and comprises a fabric layer 30 and a rubber layer 40 adhesively secured together. However, glue may deteriorate in high temperature and after a period of time of use. The fabric layer 30 is slip resistant only when the hands touching the fabric layer 30 are wet. Typically, the fabric layer 30 is not slip resistant when the hands touching the fabric layer 30 are dry.

Thus, the need for improvement still exists.

### SUMMARY OF THE INVENTION

It is therefore one object of the invention to provide an exercise mat comprising a fabric layer including a plurality of holes and having a joining surface on a first surface and a sweat absorbing surface on a second surface; and an elastic slip resistant layer having a slip resistant surface on a first surface and a joining surface on a second surface, the joining surface of the elastic slip resistant layer including a plurality of slip resistant protuberances each disposed in one of the holes.

The invention has the following advantages and benefits in comparison with the conventional art: the fabric layer and the elastic slip resistant layer are secured together to form a stronger stable member. The sweat absorbing surface can absorb sweat left by an individual doing exercise. Thus, the wet hands of the individual may have an increased slip resistant force. The slip resistant protuberances aid the dry hands of the individual in having an increased slip resistant force. The slip resistant surface can increase friction of the exercise mat with a floor so that the exercise mat can be stably placed on the floor.

The above and other objects, features and advantages of the invention will become apparent from the following detailed description taken with the accompanying drawings.

### BRIEF DESCRIPTION OF THE DRAWINGS

FIG. 1 is a perspective view of a slip resistant exercise mat according to the invention;

FIG. 2 is an exploded perspective view of FIG. 1;

FIG. 3A is a longitudinal sectional view of the fabric layer showing the slip resistant protuberances each disposed in a first hole to have a concave surface;

FIG. 3B is a view similar to FIG. 3A, where the slip resistant protuberance has an elevation slightly less than that of the first hole;

FIG. 3C is a view similar to FIG. 3A, where the slip resistant protuberance projects out of the first hole;

FIG. 4A is an enlarged view of the slip resistant protuberance of FIG. 3A;

FIG. 4B is an enlarged view of the slip resistant protuberance of FIG. 3B;

FIG. 4C is an enlarged view of the slip resistant protuberance of FIG. 3C;

FIG. 5 is an environmental view showing an individual performing push-ups on the exercise mat;

FIG. 6 is a longitudinal sectional view showing the foot pressing on the exercise mat;

FIG. 7 is a perspective view of a conventional exercise mat; and

FIG. 8 is a longitudinal sectional view of FIG. 7.

### DETAILED DESCRIPTION OF THE INVENTION

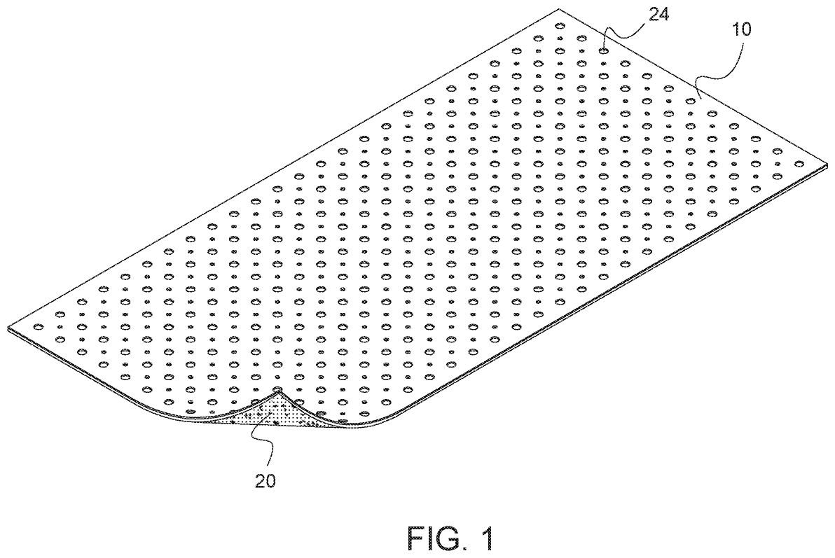

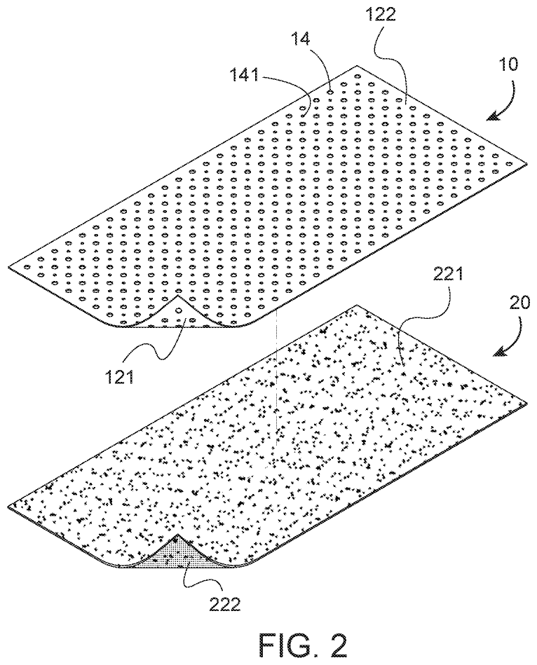

Referring to FIGS. 1 and 2, a slip resistant exercise mat in accordance with the invention comprises a fabric layer 10 and an elastic slip resistant layer 20 as discussed in detail below. The fabric layer 10 includes a plurality of first holes 14 and a plurality of second holes 141. The first hole 14 has a size the same as that of the second hole 141 or different from that of the second hole 141. As shown, a diameter of the first hole 14 is greater than that of the second hole 141. The fabric layer 10 has a joining surface 121 on a bottom and a sweat absorbing surface 122 on a top. The elastic slip resistant layer 20 has a joining surface 221 on a top and a slip resistant surface 222 on a bottom. The slip resistant surface 222 can be knurled or flat. The joining surface 221 includes a plurality of slip resistant protuberances 24 each disposed in the first hole 14 or the second hole 141. The joining surfaces 221, 121 are secured together by sulfurizing, melting or gluing with portions of the joining surface 221 moved to abutting positions of the first holes 14 and the second holes 141. The sweat absorbing surface 122 is used to absorb sweat left by an individual doing exercise. Thus, the wet hands of the individual may have an increased slip resistant force. The slip resistant protuberances 24 aid the dry hands of the individual in having an increased slip resistant force. The elastic slip resistant layer 20 can decrease force exerted by the individual doing exercise. The slip resistant surface 222 can increase friction of the exercise mat with a floor so that the exercise mat can be stably placed on the floor.

The fabric layer 10 is made of suede, nylon, Tedron, cotton or other fabric. The elastic slip resistant layer 20 is made of artificial rubber, natural rubber, thermoplastic elastomer (TPE), foam rubber or foam TPE. A top surface of the fabric layer 10 is formed with a pattern of straight, angled or crossed lines.

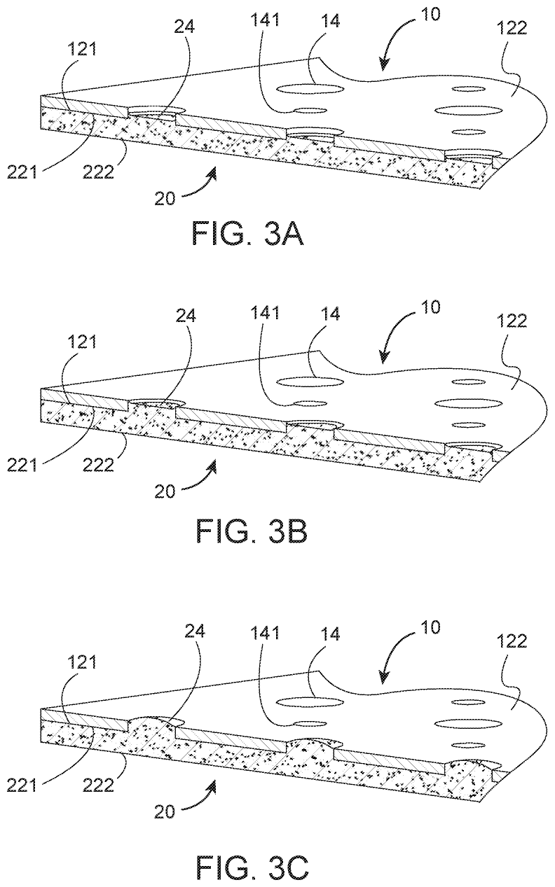

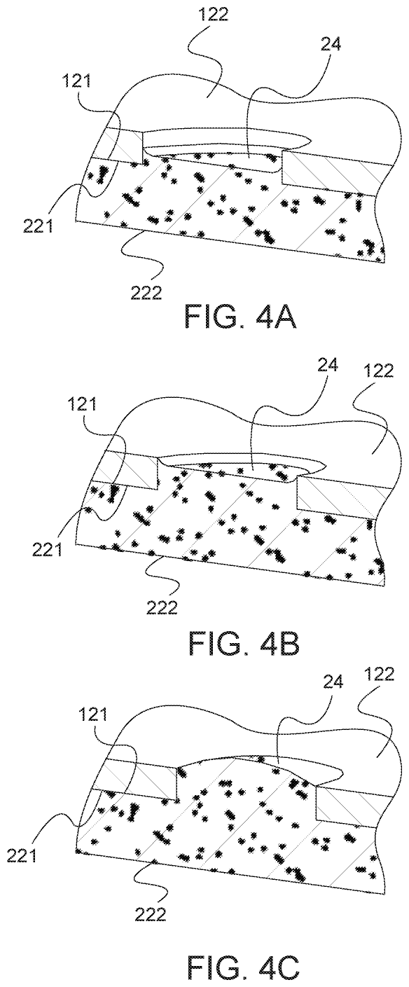

Referring to FIGS. 3A to 4C, the slip resistant protuberances 24 are formed by securing the joining surfaces 221, 121 together by sulfurizing, melting or gluing with portions of the joining surface 221 moved to abutting positions of the first holes 14 and the second holes 141. The portions of the joining surface 221 moved to abutting positions of the first holes 14 and the second holes 141 are different depending on the extent of sulfurization or melting.

As shown in FIGS. 3A and 4A specifically, the slip resistant protuberances 24 each is disposed in the first hole 141 to have a concave surface.

As shown in FIGS. 3B and 4B specifically, the slip resistant protuberance 24 has an elevation slightly less than that of the first hole 14.

As shown in FIGS. 3C and 4C specifically, the slip resistant protuberance 24 projects out of the first hole 14.

The configuration shown in FIG. 4A has an acceptable slip resistant capability, the configuration shown in FIG. 4B has a slip resistant capability greater than that shown in FIG. 4A, and the configuration shown in FIG. 4C has the best slip resistant capability.

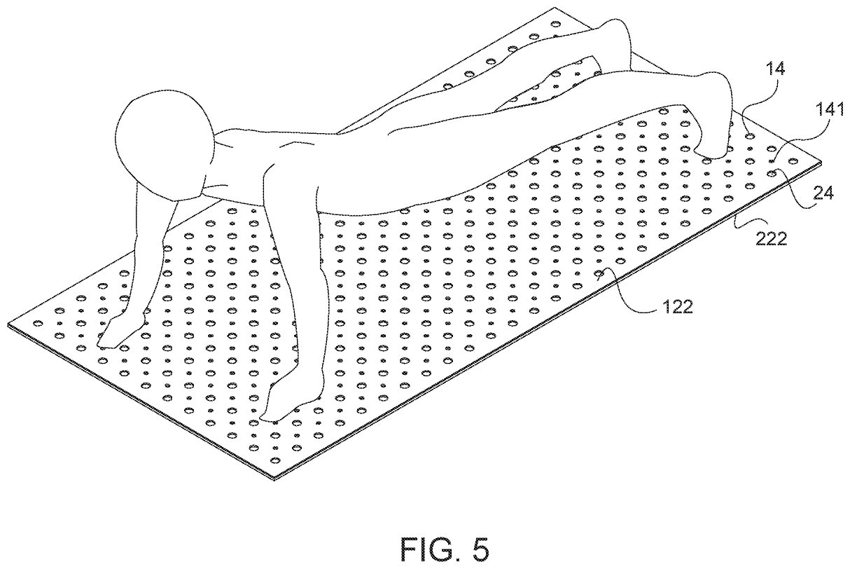

Referring to FIG. 5 in conjunction with FIG. 2, a first embodiment of the invention in use is shown. First, the slip resistant surface 222 of the elastic slip resistant layer 20 is placed on the floor. Two hands and two feet of an individual may stand on the floor to perform push-ups on the sweat absorbing surface 122 of the fabric layer 10. It is described above that the joining surfaces 221, 121 are secured together by sulfurizing, melting or gluing. As a result, the fabric layer 10 and the elastic slip resistant layer 20 are secured together to form a stronger stable member due to sulfurization, melting or gluing.

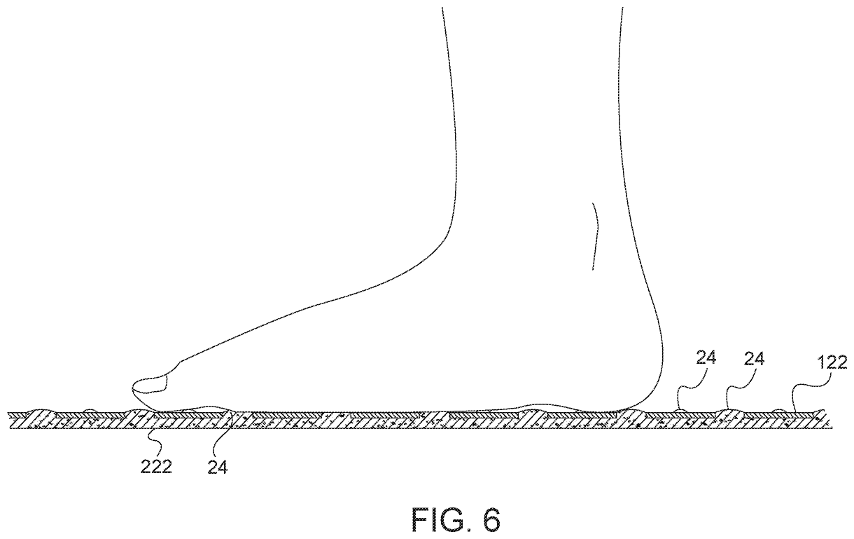

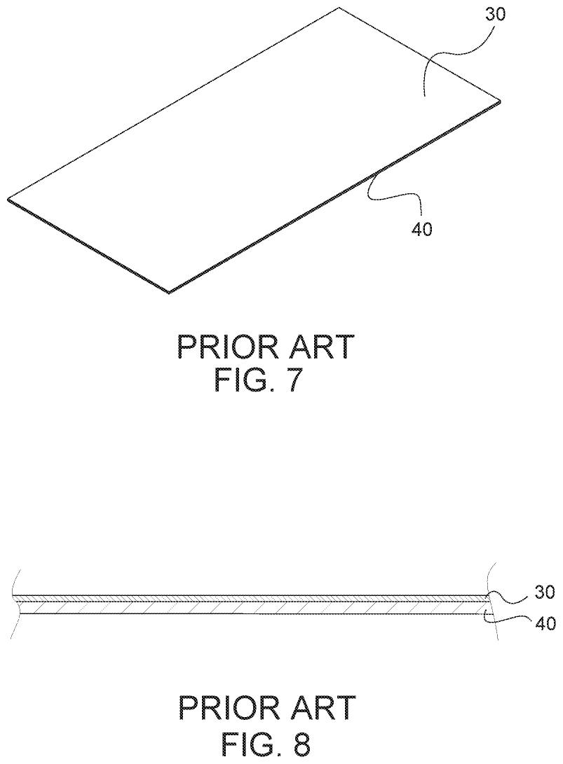

Referring to FIG. 6 in conjunction with FIG. 2, a second embodiment of the invention in use is shown. The slip resistant protuberances 24 correspond to the abutting positions of the first holes 14 and the second holes 141 and are raised. When the feet of the individual press on the sweat absorbing surface 122, weight of the individual presses and elastically deforms the slip resistant protuberances 24. And in turn, the slip resistant protuberances 24 generate friction on the soles of the feet to bring about a slip resistant effect. The slip resistant protuberances 24 returns to their original shapes after the feet have left the exercise mat.

While the invention has been described in terms of preferred embodiments, those skilled in the art will recognize that the invention can be practiced with modifications within the spirit and scope of the appended claims.

What is claimed is:

1. An exercise mat, comprising:
a fabric layer including a plurality of holes and having a joining surface on a first surface and a sweat absorbing surface on a second surface; and
an elastic slip resistant layer having a slip resistant surface on a first surface and a joining surface on a second surface, the joining surface of the elastic slip resistant layer including a plurality of slip resistant protuberances each disposed in one of the holes.

2. The exercise mat of claim 1, wherein the slip resistant protuberance is disposed in a mouth of the hole to have a concave surface.

3. The exercise mat of claim 1, wherein the slip resistant protuberance has an elevation slightly less than that of the hole.

4. The exercise mat of claim 1, wherein the slip resistant protuberance projects out of the hole.

5. The exercise mat of claim 1, wherein sizes of the holes are the same or different.

6. The exercise mat of claim 1, wherein the joining surface of the fabric layer and the joining surface of the slip resistant layer are secured together by sulfurizing, melting or gluing with portions of the joining surface of the elastic slip resistant layer moved to abutting positions of the holes.

7. The exercise mat of claim 1, wherein the second surface of the fabric layer is formed with a pattern of straight, angled or crossed lines.

8. The exercise mat of claim 1, wherein the slip resistant surface is knurled.

9. The exercise mat of claim 1, wherein the slip resistant surface is flat.
